(19) United States
(12) Patent Application Publication
(10) Pub. No.: US 2016/0286337 A1
(43) Pub. Date: Sep. 29, 2016

(54) SYSTEMS AND METHODS FOR AUDIO STREAMING

(71) Applicant: QUALCOMM Incorporated, San Diego, CA (US)

(72) Inventors: Pramod Thekkedathu Sivaraman, Alappuzha (IN); Srinu Jella, Hyderabad (IN); Ajay Kumar, Hyderabad (IN); Sai Rama Rao Aitharaju, Hyderabad (IN)

(21) Appl. No.: 14/665,717

(22) Filed: Mar. 23, 2015

(51) Int. Cl. H04W 4/00; H04W 68/00; H04W 72/00; H04M 1/725

(52) U.S. Cl. CPC H04W 4/008; H04M 1/7253; H04W 68/005; H04W 72/005

(57) ABSTRACT

A method for wireless communication is described. The method includes streaming an audio stream from a Bluetooth host device to a first Bluetooth device and a second Bluetooth device. The method also includes receiving a call at the Bluetooth host device. The method further includes sending call indications to both the first Bluetooth device and the second Bluetooth device. The method additionally includes receiving an answer call message from the first Bluetooth device. The method also includes routing the call to the first Bluetooth device and cease streaming the audio stream to the first Bluetooth device. The method further includes continuing streaming the audio stream to the second Bluetooth device.

### TECHNICAL FIELD

The present disclosure relates generally to wireless communications. More specifically, the present disclosure relates to systems and methods for audio streaming in wireless communication.

### BACKGROUND

In the last several decades, the use of electronic devices has become common. In particular, advances in electronic technology have reduced the cost of increasingly complex and useful electronic devices. Cost reduction and consumer demand have proliferated the use of electronic devices such that they are practically ubiquitous in modern society. As the use of electronic devices has expanded, so has the demand for new and improved features of electronic devices. More specifically, electronic devices that perform functions faster, more efficiently or with higher quality are often sought after.

Many electronic devices may make use of different communication technologies. For example, electronic devices may communicate using Bluetooth technology. A Bluetooth host device may communicate with multiple Bluetooth devices. The Bluetooth host device may stream an audio stream to each of the Bluetooth devices. The Bluetooth host device may receive a call while streaming the audio stream. Benefits may be realized by providing a simultaneous audio stream on one Bluetooth device while answering the call on the other Bluetooth device.

### SUMMARY

A method for wireless communication is described. The method includes streaming an audio stream from a Bluetooth host device to a first Bluetooth device and a second Bluetooth device. The method also includes receiving a call at the Bluetooth host device. The method further includes sending call indications to both the first Bluetooth device and the second Bluetooth device. The method additionally includes receiving an answer call message from the first Bluetooth device. The method also includes routing the call to the first Bluetooth device and cease streaming the audio stream to the first Bluetooth device. The method further includes continuing streaming the audio stream to the second Bluetooth device.

The method may also include terminating the call on the first Bluetooth device. The method may further include resuming streaming the audio stream to the first Bluetooth device.

The Bluetooth host device may simultaneously stream the audio stream and may send the call indications to both the first Bluetooth device and the second Bluetooth device. Continuing streaming the audio stream to the second Bluetooth device may include streaming the audio stream to the second Bluetooth device while the first Bluetooth device conducts the call.

The Bluetooth host device may establish a first channel with the first Bluetooth device and a second channel with the second Bluetooth device using a single Bluetooth transceiver. The Bluetooth host device may stream the audio stream and send the call indications to the first Bluetooth device on the first channel and the Bluetooth host device may stream the audio stream and send the call indications to the second Bluetooth device on the second channel. The Bluetooth host device may establish the call with the first Bluetooth device on the first channel while continuing to stream the audio stream to the second Bluetooth device on the second channel.

The first Bluetooth device may be a Bluetooth headset. The audio stream may be streamed using an advanced audio distribution profile (A2DP) and the call may be routed to the first Bluetooth device using a hands-free profile (HFP).

A Bluetooth host device for wireless communication is also described. The Bluetooth host device includes a processor, memory in electronic communication with the processor, and instructions stored in the memory. The instructions are executable by the processor to stream an audio stream from the Bluetooth host device to a first Bluetooth device and a second Bluetooth device. The instructions are also executable to receive a call at the Bluetooth host device. The instructions are further executable to send call indications to both the first Bluetooth device and the second Bluetooth device. The instructions are additionally executable to receive an answer call message from the first Bluetooth device. The instructions are also executable to route the call to the first Bluetooth device and cease streaming the audio stream to the first Bluetooth device. The instructions are further executable to continue streaming the audio stream to the second Bluetooth device.

An apparatus for wireless communication is also described. The apparatus includes means for streaming an audio stream from the apparatus to a first Bluetooth device and a second Bluetooth device. The apparatus also includes means for receiving a call at the apparatus. The apparatus further includes means for sending call indications to both the first Bluetooth device and the second Bluetooth device. The apparatus additionally includes means for receiving an answer call message from the first Bluetooth device. The apparatus also includes means for routing the call to the first Bluetooth device and cease streaming the audio stream to the first Bluetooth device. The apparatus further includes means for continuing streaming the audio stream to the second Bluetooth device.

A computer-program product for wireless communication is also described. The computer-program product includes a non-transitory computer-readable medium having instructions thereon. The instructions include code for causing a Bluetooth host device to stream an audio stream to a first Bluetooth device and a second Bluetooth device. The instructions also include code for causing the Bluetooth host device to receive a call. The instructions further include code for causing the Bluetooth host device to send call indications to both the first Bluetooth device and the second Bluetooth device. The instructions additionally include code for causing the Bluetooth host device to receive an answer call message from the first Bluetooth device. The instructions also include code for causing the Bluetooth host device to route the call to the first Bluetooth device and cease streaming the audio stream to the first Bluetooth device. The instructions further include code for causing the Bluetooth host device to continue streaming the audio stream to the second Bluetooth device.

### BRIEF DESCRIPTION OF THE DRAWINGS

FIG. 1 is a block diagram illustrating one configuration of a Bluetooth host device, a first Bluetooth device and a second Bluetooth device in which systems and methods for audio streaming may be implemented;

FIG. 2 is a flow diagram illustrating one configuration of a method for audio streaming by a Bluetooth host device;

FIG. 3 is a thread diagram illustrating one approach to audio streaming by a Bluetooth host device;

FIG. 4 is a thread diagram illustrating another approach to audio streaming by a Bluetooth host device according to the described systems and methods;

FIG. 5 is a flow diagram illustrating another configuration of a method for audio streaming by a Bluetooth host device; and

FIG. 6 illustrates certain components that may be included within a Bluetooth host device.

### DETAILED DESCRIPTION

Current Bluetooth technology provides for streaming an audio stream from one Bluetooth host device to multiple Bluetooth devices. Therefore, two or more listeners may simultaneously listen to an audio stream (e.g., music) from the Bluetooth host device using the Bluetooth devices (e.g., headsets). However, when the Bluetooth host device receives a call, the conventional approach is to pause the audio stream for all listeners and resume it once the call ends. This approach results in a reduced experience for those listening to the music while the call takes place. Therefore, it is desirable to receive a call and listen to music at the same time. The described systems and methods provide for simultaneously conducting a call on a first Bluetooth device while streaming an audio stream to a second Bluetooth device.

Various configurations are now described with reference to the Figures, where like reference numbers may indicate functionally similar elements. The systems and methods as generally described and illustrated in the Figures herein could be arranged and designed in a wide variety of different configurations. Thus, the following more detailed description of several configurations, as represented in the Figures, is not intended to limit scope, as claimed, but is merely representative of the systems and methods.

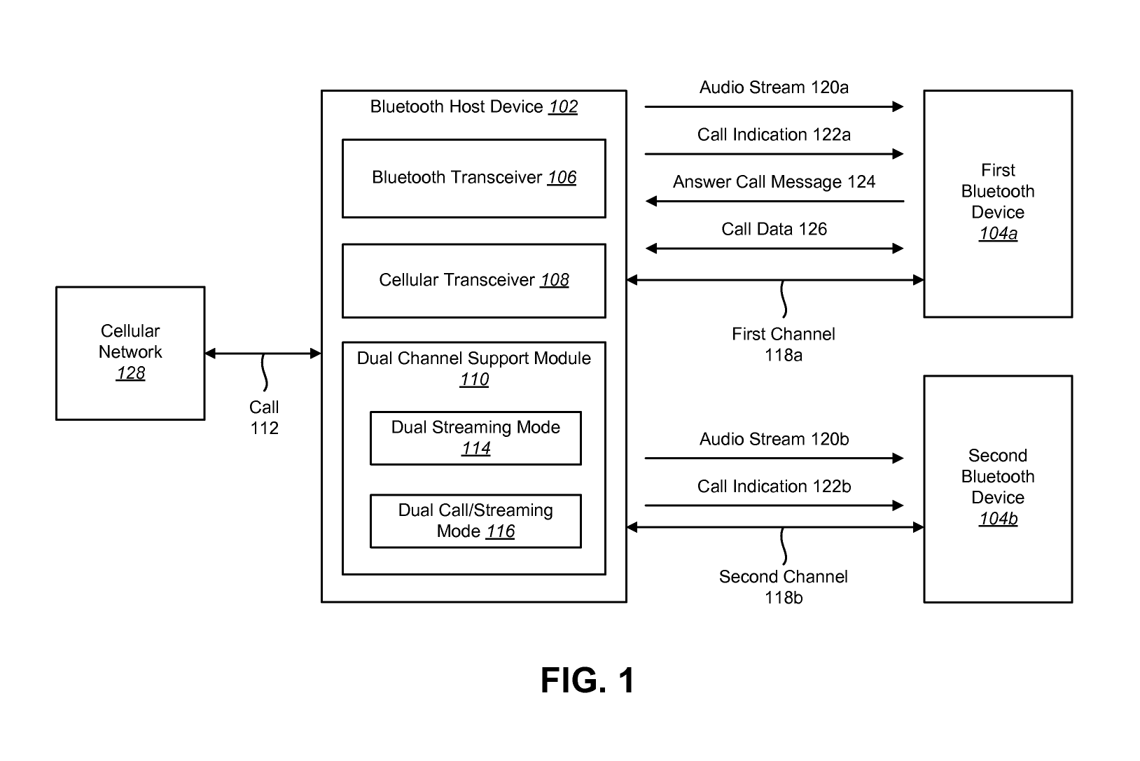

FIG. 1 is a block diagram illustrating one configuration of a Bluetooth host device 102, a first Bluetooth device 104a and a second Bluetooth device 104b in which systems and methods for audio streaming may be implemented. Wireless communication systems are widely deployed to provide various types of communication content such as voice, data, and so on.

Some mobile devices may utilize multiple communication technologies. For example, one communication technology may be utilized for mobile wireless system (MWS) (e.g., cellular) communications, while another communication technology may be utilized for wireless connectivity (WCN) communications. MWS may refer to larger wireless networks (e.g., wireless wide area networks (WWANs), cellular phone networks, Long Term Evolution (LTE) networks, Global System for Mobile Communications (GSM) networks, code division multiple access (CDMA) networks, CDMA2000 networks, wideband CDMA (W-CDMA) networks, Universal mobile Telecommunications System (UMTS) networks, Worldwide Interoperability for Microwave Access (WiMAX) networks, etc.). WCN may refer to relatively smaller wireless networks (e.g., wireless local area networks (WLANs), wireless personal area networks (WPANs), IEEE 802.11 (Wi-Fi) networks, Bluetooth (BT) networks, wireless Universal Serial Bus (USB) networks, etc.).

In one configuration, the Bluetooth host device 102 may include a cellular transceiver 108 that may communicate with a cellular network 128. The cellular network 128 may be a MWS, as described above. The cellular network 128 may be a multiple-access system capable of supporting communication with multiple mobile devices by sharing the available system resources (e.g., bandwidth and transmit power). Examples of such multiple-access systems include code division multiple access (CDMA) systems, wideband code division multiple access (W-CDMA) systems, time division multiple access (TDMA) systems, frequency division multiple access (FDMA) systems, orthogonal frequency division multiple access (OFDMA) systems, evolution-data optimized (EV-DO), single-carrier frequency division multiple access (SC-FDMA) systems, 3^{rd} Generation Partnership Project (3GPP) Long Term Evolution (LTE) systems, and spatial division multiple access (SDMA) systems.

The terms “networks” and “systems” are often used interchangeably. A CDMA network may implement a radio technology such as Universal Terrestrial Radio Access (UTRA), cdma2000, etc. UTRA includes W-CDMA and Low Chip Rate (LCR) while cdma2000 covers IS-2000, IS-95, and IS-856 standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDMA, etc. UTRA, E-UTRA, and GSM are part of Universal Mobile Telecommunication System (UMTS). Long Term Evolution (LTE) is a release of UMTS that uses E-UTRA. UTRA, E-UTRA, GSM, UMTS, and LTE are described in documents from an organization named “3rd Generation Partnership Project” (3GPP). cdma2000 is described in documents from an organization named “3rd Generation Partnership Project 2” (3GPP2).

The 3^{rd} Generation Partnership Project (3GPP) is a collaboration between groups of telecommunications associations that aims to define a globally applicable 3^{rd} generation (3G) mobile phone specification. 3GPP Long Term Evolution (LTE) is a 3GPP project aimed at improving the Universal Mobile Telecommunications System (UMTS) mobile phone standard. The 3GPP may define specifications for the next generation of mobile networks, mobile systems, and mobile devices.

A Bluetooth host device 102 may also be referred to as a wireless device, wireless communication device, a mobile device, mobile station, subscriber station, client, client station, user equipment (UE), remote station, access terminal, mobile terminal, terminal, user terminal, subscriber unit, etc. Examples of Bluetooth host device 102 include laptop or desktop computers, cellular phones, smart phones, wireless modems, e-readers, tablet devices, gaming systems, etc. Some of these devices may operate in accordance with one or more industry standards.

Communications in a mobile wireless system (e.g., a multiple-access system) may be achieved through transmissions over a wireless link. Such a wireless link may be established via a single-input and single-output (SISO), multiple-input and single-output (MISO) or a multiple-input and multiple-output (MIMO) system. A MIMO system includes transmitter(s) and receiver(s) equipped, respectively, with multiple (N_{T}) transmit antennas and multiple (N_{R}) receive antennas for data transmission. SISO and MISO systems are particular instances of a MIMO system. The MIMO system can provide improved performance (e.g., higher throughput, greater capacity or improved reliability) if the additional dimensionalities created by the multiple transmit and receive antennas are utilized.

The Bluetooth host device 102 may also include a Bluetooth transceiver 106 that may establish links with one or more Bluetooth devices 104. Bluetooth is a packet-based protocol with a master-slave structure. Bluetooth operates in the Industrial, Scientific and Medical (ISM) 2.4 GHz short-range radio frequency band (e.g., 2400-2483.5 MHz). Bluetooth uses a radio technology called frequency-hopping spread spectrum in which transmitted data is divided into packets and each packet is transmitted on a designated Bluetooth frequency (e.g., channel 118).

Communications in a Bluetooth network may be achieved based on a master polled system. The master polled system may utilize time-division duplexing (TDD) in which a Bluetooth host device 102 may send a packet to a Bluetooth device 104. In one implementation, the Bluetooth host device 102 may be a master device and the Bluetooth device 104 may be a slave device. In a master polled system, the Bluetooth host device 102 sending the packet gives the slave wireless device the ability to transmit back.

In Bluetooth, one master device may communicate with one or more slave devices. The master device may also be referred to simply as “master” and the slave device may also be referred to as “slave.” The network of master device and slave devices may be referred to as a piconet. The Bluetooth devices (e.g., master and slave devices) may switch roles, by agreement. In one implementation, the Bluetooth host device 102 may be the master device and the first Bluetooth device 104a and the second Bluetooth device 104b may be slave devices.

The Bluetooth host device 102 may establish a channel 118 with each of the Bluetooth devices 104. For example, the Bluetooth host device 102 may establish a first channel 118a with the first Bluetooth device 104a. The Bluetooth host device 102 may establish a second channel 118b with the second Bluetooth device 104b. The Bluetooth host device 102 may establish the channels 118a-b with the first Bluetooth device 104a and the second Bluetooth device 104b using a single Bluetooth transceiver 106. The channels 118a-b may be wireless Bluetooth channels. As used herein, the term “channel” may also be referred to as a Bluetooth link.

Upon establishing the channels 118a-b with the first Bluetooth device 104a and the second Bluetooth host device 104b, the Bluetooth host device 102 may have a unique address for each of the Bluetooth devices 104a-b. Therefore, the Bluetooth host device 102 may transmit data to the first Bluetooth device 104a using the address for the first Bluetooth device 104a. Similarly, the Bluetooth host device 102 may transmit data to the second Bluetooth device 104b using its unique address.

The first Bluetooth device 104a and the second Bluetooth device 104b may be Bluetooth devices that are capable of receiving an audio stream 120 from the Bluetooth host device 102. Furthermore, the first Bluetooth device 104a and the second Bluetooth device 104b may be capable of playing the received audio stream 120. For example, the first Bluetooth device 104a or the second Bluetooth device 104b may be a Bluetooth-enabled headset, headphone, speakers, car stereo system, etc.

The Bluetooth host device 102 may stream the audio stream 120 using a Bluetooth profile. In order to use Bluetooth technology, a device (e.g., Bluetooth host device 102 or Bluetooth device 104) must be compatible with a subset of Bluetooth profiles necessary to use desired services. A Bluetooth profile is a specification regarding an aspect of Bluetooth-based wireless communication between devices. Therefore, the way a device uses Bluetooth technology depends on its profile capabilities. The profiles provide standards that manufacturers follow to allow devices to use Bluetooth in an intended manner.

In one implementation, the Bluetooth host device 102 may stream the audio stream 120 using an advanced audio distribution profile (A2DP). The A2DP profile may define how multimedia audio can be streamed from the Bluetooth host device 102 to the Bluetooth devices 104 over a Bluetooth channel 118.

In one approach, the Bluetooth host device 102 may stream audio stream 120 to each of the first Bluetooth device 104a and the second Bluetooth device 104b. The Bluetooth host device 102 may send the audio stream 120a to the first Bluetooth device 104a on the first channel 118a. The Bluetooth host device 102 may send the audio stream 120b to the second Bluetooth device 104b on the second channel 118b.

In an example where the audio stream 120 is music, two different users (one using the first Bluetooth device 104a and the other using the second Bluetooth device 104b, for instance) may simultaneously listen to the music streamed from the Bluetooth host device 102. While multiple audio streams 120a-b are depicted in FIG. 1, each audio stream 120a-b may include the same information (e.g., music) transmitted over the different channels 118a-b.

The Bluetooth host device 102 may receive a call 112. In one configuration, the call 112 may be a call that is received over a cellular network 128. In this case, the call 112 may be received by the cellular transceiver 108.

At least one of the Bluetooth devices 104a-b may be capable of receiving a call 112 from the Bluetooth host device 102. For example, one or both of the Bluetooth devices 104a-b may be a Bluetooth headset. In one configuration, the Bluetooth host device 102 and at least one of the Bluetooth devices 104a-b may use a hands-free profile (HFP) to route the call 112 through the Bluetooth host device 102 to a Bluetooth device 104.

The HFP is another Bluetooth profile that describes how a gateway device (e.g., Bluetooth host device 102) can be used to place and receive calls for a hand-free device (e.g., Bluetooth device 104). With HFP, the Bluetooth host device 102 and a Bluetooth device 104 may communicate using attention (AT) commands to conduct a call (e.g., answer a call and terminate a call).

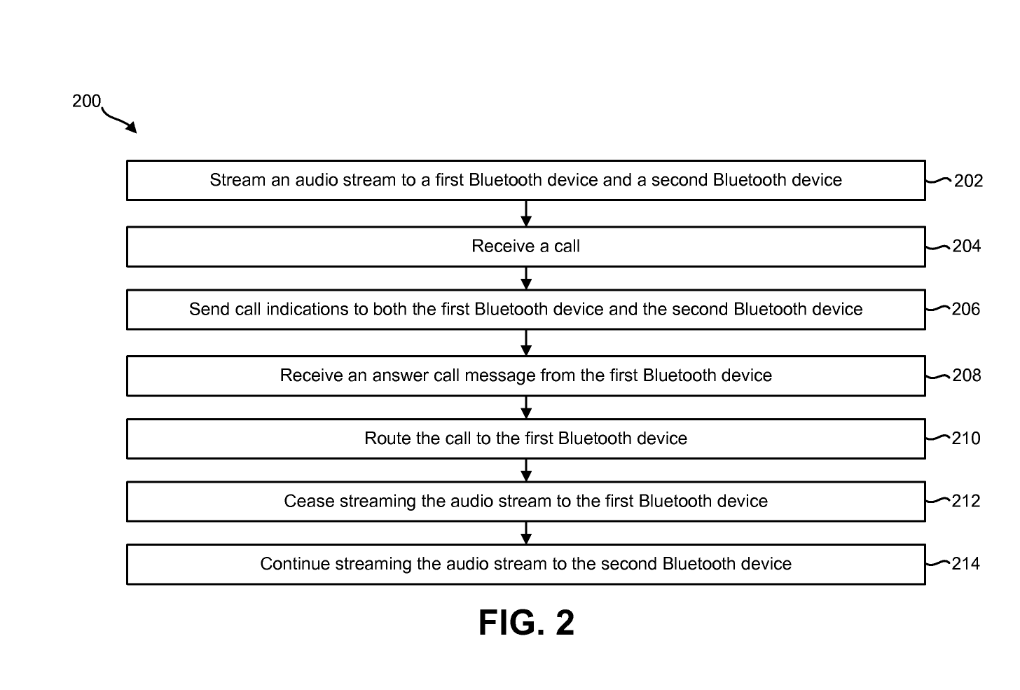

In one approach, when two persons are listening to the music using the first Bluetooth device 104a and the second Bluetooth device 104b, when a call 112 comes in and one person accepts it, the audio streaming stops on both Bluetooth device 104a-b. When the second listener wants to continue streaming of the music, this approach restricts the audio stream 120 and only resumes streaming when the call 112 ends. In other words, with this approach the Bluetooth host device 102 may pause the music (e.g., audio stream 120) and may resume it once the call 112 ends. While the call 112 is taking place, the second user may sit in silence. If the call 112 lasts for a long time, this may put both of the users of the Bluetooth devices 104 in an uncomfortable situation. This approach is described in connection with FIG. 2.

In one example of this approach, the Bluetooth host device 102 may be streaming an audio stream 120 to the first Bluetooth device 104a and the second Bluetooth device 104b when the Bluetooth host device 102 receives a call 112. When a user of the first Bluetooth device 104a answers the call 112, the Bluetooth host device 102 may stop the audio stream 120b to the second Bluetooth device 104b while the call 112 takes place on the first Bluetooth device 104. Therefore, it may be beneficial to receive a call 112 on the first Bluetooth device 104a and listen to an audio stream 120 on the second Bluetooth device 104b at the same time.

In another approach, a Bluetooth host device 102 may establish new channels 118 with the Bluetooth devices 104 upon receiving a call 112. With this approach, each time a call 112 is received, the Bluetooth host device 102 must establish separate dedicated channels 118 for the call data and the audio data. However, this approach is problematic in that it requires separate dedicated channels 118, which may increase resource consumption and energy use. Furthermore, this approach does not allow sending two different types of data on the same channel 118. Therefore, it may be beneficial to simultaneously stream an audio stream 120 and send call indications 122 over the channels 118 used for streaming the audio stream 120.

According to the described systems and methods, the Bluetooth host device 102 may stream an audio stream 120 to one Bluetooth device 104 while simultaneously sending the AT commands to the another Bluetooth device 104 receiving a call 112. In one implementation, the Bluetooth host device 102 may include a dual channel support module 110. The dual channel support module 110 provides support for operations on two or more Bluetooth channels 118.

The dual channel support module 110 may be included as part of the operating system of the Bluetooth host device 102. The dual channel support module 110 may include software modifications in the Bluetooth Stack Audio and Hands-Free Profile state machines for simultaneous handling of dual channels 118.

The dual channel support module 110 may operate according to at least two modes: a dual streaming mode 114 and a dual call/streaming mode 116. In the dual streaming mode 114, the Bluetooth host device 102 may stream an audio stream 120 to at least two Bluetooth devices 104 over separate channels 118. For example, while in dual streaming mode 114, the Bluetooth host device 102 may stream an audio stream 120a to the first Bluetooth device 104a over the first channel 118a. The Bluetooth host device 102 may also stream the audio stream 120b to the second Bluetooth device 104b over the second channel 118b.

As described above, the Bluetooth device 104 may use A2DP to stream the audio stream 120 to the Bluetooth devices 104. Therefore, the dual streaming mode 114 may also be referred to as a dual A2DP mode.

When the Bluetooth host device 102 receives a call 112 while streaming an audio stream 120 to two or more Bluetooth devices 104, the dual channel support module 110 may switch to dual call/streaming mode 116. The Bluetooth host device 102 may send call indications 122a-b to the Bluetooth devices 104. A call indication 122 may be a signal that produces an audible sound or other indication of the received call 112 at the Bluetooth devices 104a-b. In one implementation, the call indication 122 may be a +CIEV command.

The Bluetooth host device 102 may use HFP to send and receive AT commands to/from the Bluetooth devices 104 while simultaneously streaming an audio stream 120 using A2DP. Therefore, the dual call/streaming mode 116 may be referred to as a dual HF-A2DP mode.

In one example of dual call/streaming mode 116 operation, the Bluetooth host device 102 may send one call indication 122a to the first Bluetooth device 104a over the first channel 118a. The Bluetooth host device 102 may send another call indication 122b to the second Bluetooth device 104b over the second channel 118b. The Bluetooth host device 102 may simultaneously stream the audio stream 120a-b and send the call indications 122a to both the first Bluetooth device 104a and the second Bluetooth device 104b.

The Bluetooth host device 102 may receive an answer call message 124 from a Bluetooth device 104. For example, a user of the first Bluetooth device 104a may hear the call indication 122a and may indicate that the first Bluetooth device 104a should answer the call 112. This may involve pressing an answer call button, or interacting with some other user interface on the first Bluetooth device 104a to instruct the first Bluetooth device 104a to answer the call 112.

The first Bluetooth device 104a may send the answer call message 124 to the Bluetooth host device 102 to indicate that the call 112 may be answered by the first Bluetooth device 104a. In one implementation, the answer call message 124 may be an ATA command.

Upon receiving the answer call message 124, the Bluetooth host device 102 may route the call 112 to the Bluetooth device 104 that sent the answer call message 124. The Bluetooth host device 102 may also cease streaming the audio stream to this Bluetooth device 104. For example, if the first Bluetooth device 104a sends the answer call message 124, then the Bluetooth host device 102 may stop streaming the audio stream 120a to the first Bluetooth device 104a and may route the call 112 to the first Bluetooth device 104a over the first channel 118a. In one implementation, the call 112 may be routed to the first Bluetooth device 104a using HFP. The Bluetooth host device 102 may exchange call data 126 with the first Bluetooth device 104a and the cellular network 128.

While the first Bluetooth device 104a conducts the call 112, the Bluetooth host device 102 may continue streaming the audio stream 120b to the second Bluetooth device 104b. Therefore, while one user is on the call 112 (e.g., the user of the first Bluetooth device 104a), the other user (e.g., the user of the second Bluetooth device 104b) may continue to listen to the audio stream 120. In other words, the Bluetooth host device 102 may establish the call 112 with the first Bluetooth device 104a on the first channel 118a while continuing to stream the audio stream 120b to the second Bluetooth device 104b on the second channel 118b.

At some point, the call 112 on the first Bluetooth device 104a may be terminated. In one case, the call 112 may be terminated by the cellular network 128. In this case, the Bluetooth host device 102 may send the first Bluetooth device 104a a terminate call message (e.g., AT+CHUP command). In another case, the call 112 may be terminated by the first Bluetooth device 104a.

Upon terminating the call 112, the dual channel support module 110 may switch back to dual streaming mode 114. The Bluetooth host device 102 may resume streaming the audio stream 120a to the first Bluetooth device 104a. This transition is handled gracefully without impacting the other user involved in audio streaming.

The Bluetooth host device 102 may also perform call swapping between the Bluetooth devices 104. In one scenario, user-A is in a call 112 using the first Bluetooth device 104a and user-B is receiving the audio stream 120b using the second Bluetooth device 104b (listening to music, for instance). For example, the users may be family members that are sharing the music stored on the Bluetooth host device 102.

During the call 112, user-A may desire to swap the call to user-B. As described herein, both channels 118a-b are active during the audio streaming and call 112. Because there is no dedicated channel for the call data 126, the call 112 can be swapped from the first Bluetooth device 104a (e.g., user-A) to the second Bluetooth device 104b (e.g., user-B) and the audio stream 120a can resume on the first Bluetooth device 104a. Therefore, the Bluetooth host device 102 may internally swap which Bluetooth device 104 is actively participating in the call 112 and which Bluetooth device 104 is receiving the audio stream 120.

The described systems and methods may provide an improved user experience. For example, one user may answer a call 112 while another user continues to listen to music. This provides seamless audio streaming to the other users and only one Bluetooth device 104 is involved in the call 112. Furthermore, the described systems and methods provide an automatic transition of the audio stream 120 to the recipient who was in the call 112 once the call 112 is terminated or swapped. This transition happens without impacting the other users involved in audio streaming.

The described systems and methods provide no power penalty while providing improved functionality.

FIG. 2 is a flow diagram illustrating one configuration of a method 200 for audio streaming by a Bluetooth host device 102. The Bluetooth host device 102 may be in communication with a first Bluetooth device 104a and a second Bluetooth device 104b. For example, the Bluetooth host device 102 may establish a first channel 118a with the first Bluetooth device 104a and a second channel 118b with the second Bluetooth device 104b.

The Bluetooth host device 102 may stream 202 an audio stream 120 to the first Bluetooth device 104a and the second Bluetooth device 104b. The Bluetooth host device 102 may stream 202 the audio stream 120 to the Bluetooth devices 104 over separate channels 118. For example, the Bluetooth host device 102 may stream 202 the audio stream 120a to the first Bluetooth device 104a over the first channel 118a. The Bluetooth host device 102 may also stream 202 the audio stream 120b to the second Bluetooth device 104b over the second channel 118b. The Bluetooth device 104 may use A2DP to stream 202 the audio stream 120 to the Bluetooth devices 104.

The Bluetooth host device 102 may receive 204 a call 112. For example, the Bluetooth host device 102 may receive an incoming call message from a cellular network 128.

The Bluetooth host device 102 may send 206 call indications 122a-b to both the first Bluetooth device 104a and the second Bluetooth device 104b. A call indication 122 may be a signal that produces an audible sound or other indication of the received call 112 at the Bluetooth devices 104a-b. In one implementation, the call indication 122 may be a +CIEV command.

The Bluetooth host device 102 may send 206 one call indication 122a to the first Bluetooth device 104a over the first channel 118a. The Bluetooth host device 102 may send 206 another call indication 122b to the second Bluetooth device 104b over the second channel 118b. The Bluetooth host device 102 may simultaneously stream the audio stream 120a-b and send the call indications 122a to both the first Bluetooth device 104a and the second Bluetooth device 104b.

The Bluetooth host device 102 may receive 208 an answer call message 124 from the first Bluetooth device 104a. For example, the first Bluetooth device 104a may send the answer call message 124 to the Bluetooth host device 102 to indicate that the call 112 may be answered by the first Bluetooth device 104a. In one implementation, the answer call message 124 may be an ATA command.

Upon receiving the answer call message 124, the Bluetooth host device 102 may route 210 the call 112 to the first Bluetooth device 104a. The Bluetooth host device 102 may exchange the call data 126 with the first Bluetooth device 104a and the cellular network 128. The Bluetooth host device 102 may also use HFP to send and receive AT commands to/from the first Bluetooth device 104a.

The Bluetooth host device 102 may cease 212 streaming the audio stream 120 to the first Bluetooth device 104a. In other words, upon establishing the call 112 with the first Bluetooth device 104a, the Bluetooth host device 102 may stop transmitting the audio stream 120a to the first Bluetooth device 104a over the first channel 118a.

The Bluetooth host device 102 may continue streaming 214 the audio stream 120b to the second Bluetooth device 104b. While the first Bluetooth device 104a conducts the call 112 on the first channel 118a, the Bluetooth host device 102 may continue streaming 214 the audio stream 120b to the second Bluetooth device 104b on the second channel 118b. Therefore, while the user of the first Bluetooth device 104a is on the call 112, the user of the second Bluetooth device 104b may continue to listen to the audio stream 120.

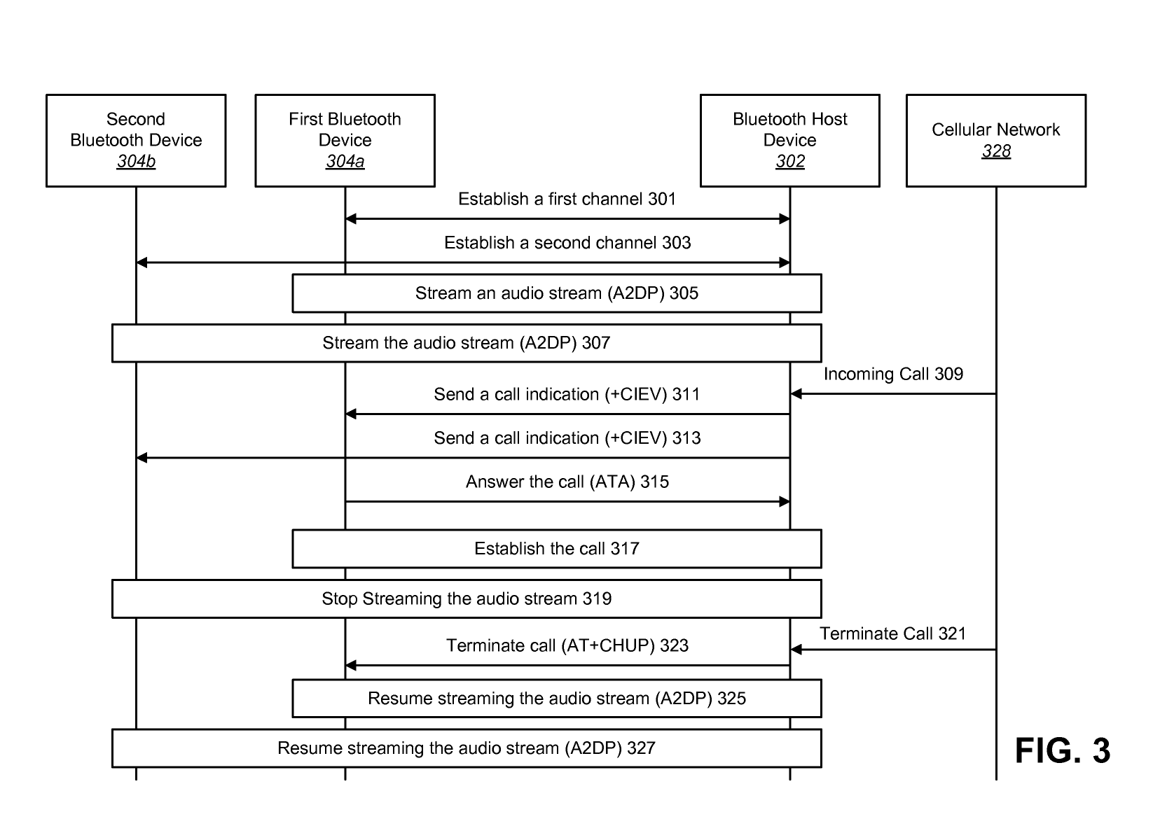

FIG. 3 is a thread diagram illustrating one approach to audio streaming by a Bluetooth host device 102. The Bluetooth host device 302 may connect to a first Bluetooth device 304a and a second Bluetooth device 304b over a Bluetooth link. The Bluetooth host device 302 may establish 301 a first channel 118a with a first Bluetooth device 304a. The Bluetooth host device 302 may also establish 303 a second channel 118b with a second Bluetooth device 304b. In one configuration, the first Bluetooth device 304a and the second Bluetooth device 304b may be Bluetooth headsets.

The Bluetooth host device 302 may stream 305 an audio stream 120a to the first Bluetooth device 304a. For example, the Bluetooth host device 302 may stream 305 the audio stream 120a to the first Bluetooth device 304a over the first channel 118a using A2DP. The Bluetooth host device 302 may simultaneously stream 307 the audio stream 120b to the second Bluetooth device 304b over the second channel 118b using A2DP.

The Bluetooth host device 302 may receive 309 an incoming call 112 from the cellular network 328. For example, the cellular network 328 may send a page that indicates an incoming call 112 for the Bluetooth host device 302.

The Bluetooth host device 302 may send 311 a call indication 122a (e.g., +CIEV command) to the first Bluetooth device 304a. The Bluetooth host device 302 may also send 313 a call indication 122b (e.g., +CIEV command) to the second Bluetooth device 304b.

The first Bluetooth device 304a may answer the call 112 by sending 315 an answer call message 124 (e.g., ATA command) to the Bluetooth host device 302. Upon receiving the answer call message 124, the Bluetooth host device 302 may establish 317 the call 112 on the first Bluetooth device 304a. This may be accomplished by routing call data 126 (e.g., call audio) to the first Bluetooth device 304a and exchanging AT commands using HFP.

According to this approach to audio streaming, the Bluetooth host device 302 may stop streaming 319 the audio stream 120b to the second Bluetooth device 304b while the call 112 takes place. As described above, this may result in an undesirable user experience, as the audio stream 120b (e.g., music) on the second Bluetooth device 304b is interrupted for the duration of the call 112.

The Bluetooth host device 302 may receive 321 a terminate call indication from the cellular network 328. The Bluetooth host device 302 may send 323 a terminate call command (e.g., AT+CHUP command) to the first Bluetooth device 304a to terminate the call 112.

Upon terminating the call 112, the Bluetooth host device 302 may resume streaming 325 the audio stream 120a to the first Bluetooth device 304a using A2DP. The Bluetooth host device 302 may also resume streaming 327 the audio stream 120b to the second Bluetooth device 304b using A2DP.

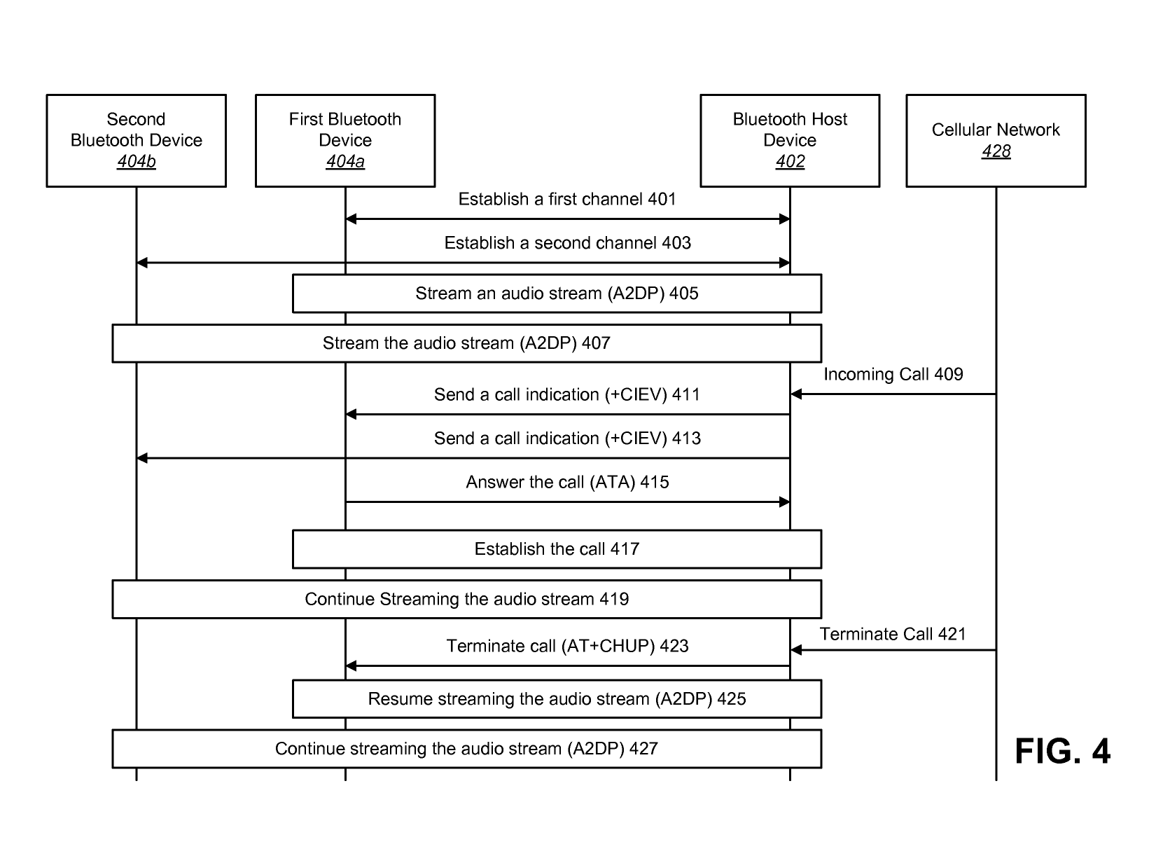

FIG. 4 is a thread diagram illustrating another approach to audio streaming by a Bluetooth host device 102 according to the described systems and methods. The Bluetooth host device 402 may connect to a first Bluetooth device 404a and a second Bluetooth device 404b over a Bluetooth link. The Bluetooth host device 402 may establish 401 a first channel 118a with a first Bluetooth device 404a. The Bluetooth host device 402 may also establish 403 a second channel 118b with a second Bluetooth device 404b. In one configuration, the first Bluetooth device 404a and the second Bluetooth device 404b may be Bluetooth headsets.

The Bluetooth host device 402 may stream 405 an audio stream 120a (e.g., music audio) to the first Bluetooth device 404a over the first channel 118a using A2DP. The Bluetooth host device 402 may simultaneously stream 407 the audio stream 120b to the second Bluetooth device 404b over the second channel 118b using A2DP.

The Bluetooth host device 402 may receive 409 an incoming call 112 from the cellular network 428. For example, the cellular network 428 may send a page that indicates an incoming call 112 for the Bluetooth host device 402.

The Bluetooth host device 402 may send 411 a call indication 122a (e.g., +CIEV command) to the first Bluetooth device 404a. The Bluetooth host device 402 may also send 413 a call indication 122b (e.g., +CIEV command) to the second Bluetooth device 404b.

The first Bluetooth device 404a may answer the call 112 by sending 415 an answer call message 124 (e.g., ATA command) to the Bluetooth host device 402. Upon receiving the answer call message 124, the Bluetooth host device 402 may establish 417 the call 112 on the first Bluetooth device 404a. This may be accomplished by routing call data 126 (e.g., call audio) to the first Bluetooth device 404a and exchanging AT commands using HFP.

According to this approach to audio streaming, the Bluetooth host device 402 may continue streaming 419 the audio stream 120b to the second Bluetooth device 404b while the call 112 takes place. While the first Bluetooth device 104a conducts the call 112 on the first channel 118a, the Bluetooth host device 102 may continue streaming 419 the audio stream 120b to the second Bluetooth device 104b on the second channel 118b. This may produce a more enjoyable user experience (as compared to the approach described in connection with FIG. 3) as the audio stream 120b (e.g., music) on the second Bluetooth device 404b continues for the duration of the call 112.

The Bluetooth host device 402 may receive 421 a terminate call indication from the cellular network 428. The Bluetooth host device 402 may send 423 a terminate call command (e.g., AT+CHUP command) to the first Bluetooth device 404a to terminate the call 112.

Upon terminating the call 112, the Bluetooth host device 402 may resume streaming 425 the audio stream 120a to the first Bluetooth device 404a. The Bluetooth host device 402 may also continue streaming 427 the audio stream 120b to the second Bluetooth device 404b. Therefore, upon terminating the call 112, the Bluetooth host device 402 may seamlessly resume streaming the audio stream 120 to both the first Bluetooth device 404a and the second Bluetooth device 404b.

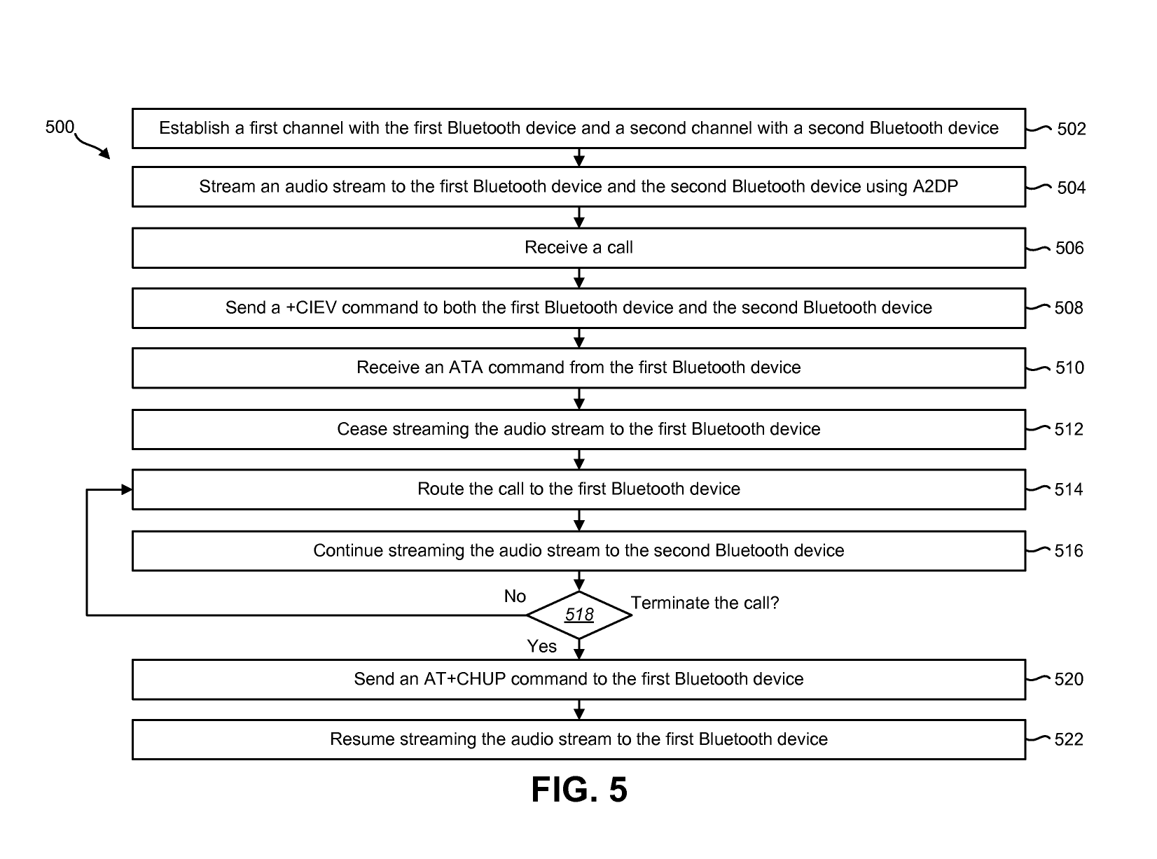

FIG. 5 is a flow diagram illustrating another configuration of a method 500 for audio streaming by a Bluetooth host device 102. The Bluetooth host device 102 may establish 502 a first channel 118a with the first Bluetooth device 104a and a second channel 118b with a second Bluetooth device 104b.

The Bluetooth host device 102 may stream 504 an audio stream 120 to the first Bluetooth device 104a and the second Bluetooth device 104b using A2DP. The Bluetooth host device 102 may stream 504 the audio stream 120 to the Bluetooth devices 104 over the separate channels 118a-b. For example, the Bluetooth host device 102 may stream 504 the audio stream 120a to the first Bluetooth device 104a over the first channel 118a. The Bluetooth host device 102 may also stream 504 the audio stream 120b to the second Bluetooth device 104b over the second channel 118b. The Bluetooth device 104 may use A2DP to stream 504 the audio stream 120 to the Bluetooth devices 104a-b.

The Bluetooth host device 102 may receive 506 a call 112. For example, the Bluetooth host device 102 may receive an incoming call message (e.g., page) from a cellular network 128.

The Bluetooth host device 102 may send 508 +CIEV command to both the first Bluetooth device 104a and the second Bluetooth device 104b. The +CIEV command may be a call indication 122. The +CIEV command may produce an audible sound or other indication of the received call 112 at the Bluetooth devices 104a-b.

The Bluetooth host device 102 may receive 510 an ATA command from the first Bluetooth device 104a. The ATA command may be an answer call message 124 sent from the first Bluetooth device 104a in response to the +CIEV command.

Upon receiving the ATA command, the Bluetooth host device 102 may cease 512 streaming the audio stream 120 to the first Bluetooth device 104a. The Bluetooth host device 102 may route 514 the call 112 to the first Bluetooth device 104a. For example, the Bluetooth host device 102 may route 514 call data 126 to the first Bluetooth device 104a. The Bluetooth host device 102 may exchange the call data 126 with the first Bluetooth device 104a and the cellular network 128. The Bluetooth host device 102 may use HFP to send and receive AT commands to/from the first Bluetooth device 104a.

The Bluetooth host device 102 may continue streaming 516 the audio stream 120b to the second Bluetooth device 104b. While the first Bluetooth device 104a conducts the call 112 on the first channel 118a, the Bluetooth host device 102 may continue streaming 516 the audio stream 120b to the second Bluetooth device 104b on the second channel 118b. Therefore, while the user of the first Bluetooth device 104a is on the call 112, the user of the second Bluetooth device 104b may continue to listen to the audio stream 120 uninterrupted.

The Bluetooth host device 102 may determine 518 whether to terminate the call 112. If the Bluetooth host device 102 determines 518 that the call 112 is still in progress, the Bluetooth host device 102 may continue to route 514 the call 112 to the first Bluetooth device 104a and may continue streaming 516 the audio stream 120b to the second Bluetooth device 104b.

If the Bluetooth host device 102 determines 518 that the call 112 should be terminated, then the Bluetooth host device 102 may send 520 an AT+CHUP command to the first Bluetooth device 104a to terminate the call 112. For example, if the Bluetooth host device 102 receives a terminate call indication from the cellular network 128, the Bluetooth host device 102 may send 520 the AT+CHUP command to the first Bluetooth device 104a.

Upon terminating the call 112, the Bluetooth host device 102 may resume streaming 522 the audio stream 120a to the first Bluetooth device 104a. At this point, both the first Bluetooth device 104a and the second Bluetooth device 104b may receive the audio stream 120.

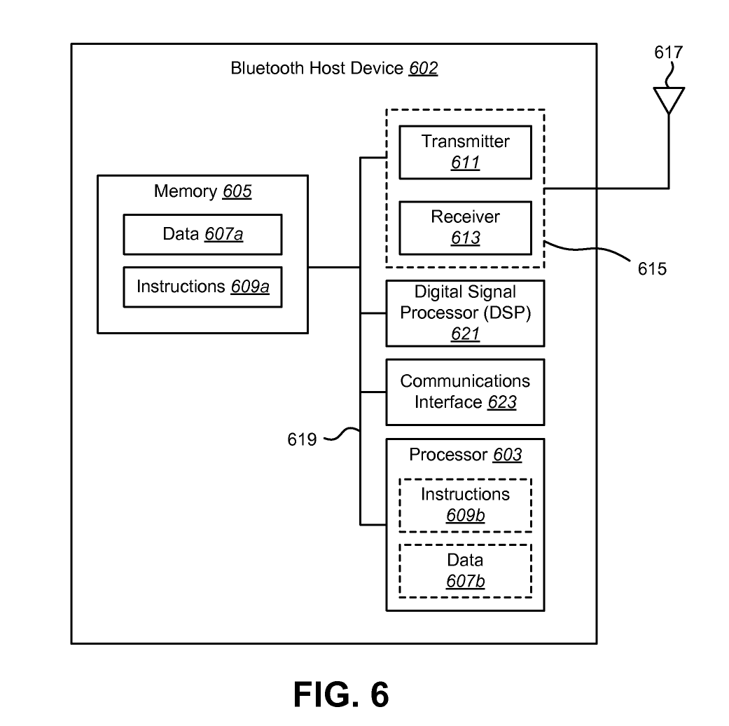

FIG. 6 illustrates certain components that may be included within a Bluetooth host device 602. The Bluetooth host device 602 may be a wireless device, an access terminal, a mobile station, a user equipment (UE), a laptop computer, a desktop computer, a wireless headset, etc. For example, the Bluetooth host device 602 may be a Bluetooth host device 102 of FIG. 1.

The Bluetooth host device 602 includes a processor 603. The processor 603 may be a general purpose single- or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, etc. The processor 603 may be referred to as a central processing unit (CPU). Although just a single processor 603 is shown in the Bluetooth host device 602 of FIG. 6, in an alternative configuration, a combination of processors (e.g., an ARM and DSP) could be used.

The Bluetooth host device 602 also includes memory 605 in electronic communication with the processor (i.e., the processor can read information from and/or write information to the memory). The memory 605 may be any electronic component capable of storing electronic information. The memory 605 may be configured as random access memory (RAM), read-only memory (ROM), magnetic disk storage media, optical storage media, flash memory devices in RAM, on-board memory included with the processor, EPROM memory, EEPROM memory, registers and so forth, including combinations thereof.

Data 607a and instructions 609a may be stored in the memory 605. The instructions may include one or more programs, routines, sub-routines, functions, procedures, code, etc. The instructions may include a single computer-readable statement or many computer-readable statements. The instructions 609a may be executable by the processor 603 to implement the methods disclosed herein. Executing the instructions 609a may involve the use of the data 607a that is stored in the memory 605. When the processor 603 executes the instructions 609, various portions of the instructions 609b may be loaded onto the processor 603, and various pieces of data 607b may be loaded onto the processor 603.

The Bluetooth host device 602 may also include a transmitter 611 and a receiver 613 to allow transmission and reception of signals to and from the Bluetooth host device 602 via an antenna 617. The transmitter 611 and receiver 613 may be collectively referred to as a transceiver 615. The Bluetooth host device 602 may also include (not shown) multiple transmitters, multiple antennas, multiple receivers and/or multiple transceivers.

The Bluetooth host device 602 may include a digital signal processor (DSP) 621. The Bluetooth host device 602 may also include a communications interface 623. The communications interface 623 may allow a user to interact with the Bluetooth host device 602.

The various components of the Bluetooth host device 602 may be coupled together by one or more buses, which may include a power bus, a control signal bus, a status signal bus, a data bus, etc. For the sake of clarity, the various buses are illustrated in FIG. 6 as a bus system 619.

In the above description, reference numbers have sometimes been used in connection with various terms. Where a term is used in connection with a reference number, this may be meant to refer to a specific element that is shown in one or more of the Figures. Where a term is used without a reference number, this may be meant to refer generally to the term without limitation to any particular Figure.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

The term “processor” should be interpreted broadly to encompass a general purpose processor, a central processing unit (CPU), a microprocessor, a digital signal processor (DSP), a controller, a microcontroller, a state machine, and so forth. Under some circumstances, a “processor” may refer to an application specific integrated circuit (ASIC), a programmable logic device (PLD), a field programmable gate array (FPGA), etc. The term “processor” may refer to a combination of processing devices, e.g., a combination of a digital signal processor (DSP) and a microprocessor, a plurality of microprocessors, one or more microprocessors in conjunction with a digital signal processor (DSP) core, or any other such configuration.

The term “memory” should be interpreted broadly to encompass any electronic component capable of storing electronic information. The term memory may refer to various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or optical data storage, registers, etc. Memory is said to be in electronic communication with a processor if the processor can read information from and/or write information to the memory. Memory that is integral to a processor is in electronic communication with the processor.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may comprise a single computer-readable statement or many computer-readable statements.

The functions described herein may be implemented in software or firmware being executed by hardware. The functions may be stored as one or more instructions on a computer-readable medium. The terms “computer-readable medium” or “computer-program product” refers to any tangible storage medium that can be accessed by a computer or a processor. By way of example, and not limitation, a computer-readable medium may include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-Ray® disc where disks usually reproduce data magnetically, while discs reproduce data optically with lasers. It should be noted that a computer-readable medium may be tangible and non-transitory. The term “computer-program product” refers to a computing device or processor in combination with code or instructions (e.g., a “program”) that may be executed, processed or computed by the computing device or processor. As used herein, the term “code” may refer to software, instructions, code or data that is/are executable by a computing device or processor.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

Further, it should be appreciated that modules and/or other appropriate means for performing the methods and techniques described herein, such as illustrated by FIG. 2 and FIG. 5, can be downloaded and/or otherwise obtained by a device. For example, a device may be coupled to a server to facilitate the transfer of means for performing the methods described herein. Alternatively, various methods described herein can be provided via a storage means (e.g., random access memory (RAM), read only memory (ROM), a physical storage medium such as a compact disc (CD) or floppy disk, etc.), such that a device may obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the systems, methods, and apparatus described herein without departing from the scope of the claims.

What is claimed is:

1. A method for wireless communication, comprising:
streaming an audio stream from a Bluetooth host device to a first Bluetooth device and a second Bluetooth device;
receiving a call at the Bluetooth host device;
sending call indications to both the first Bluetooth device and the second Bluetooth device;
receiving an answer call message from the first Bluetooth device;
routing the call to the first Bluetooth device and cease streaming the audio stream to the first Bluetooth device; and
continue streaming the audio stream to the second Bluetooth device.

2. The method of claim 1, further comprising:
terminating the call on the first Bluetooth device; and
resume streaming the audio stream to the first Bluetooth device.

3. The method of claim 1, wherein the Bluetooth host device simultaneously streams the audio stream and sends the call indications to both the first Bluetooth device and the second Bluetooth device.

4. The method of claim 1, wherein continue streaming the audio stream to the second Bluetooth device comprises streaming the audio stream to the second Bluetooth device while the first Bluetooth device conducts the call.

5. The method of claim 1, wherein the Bluetooth host device establishes a first channel with the first Bluetooth device and a second channel with the second Bluetooth device using a single Bluetooth transceiver.

6. The method of claim 5, wherein the Bluetooth host device streams the audio stream and sends the call indications to the first Bluetooth device on the first channel and the Bluetooth host device streams the audio stream and sends the call indications to the second Bluetooth device on the second channel.

7. The method of claim 5, wherein the Bluetooth host device establishes the call with the first Bluetooth device on the first channel while continuing to stream the audio stream to the second Bluetooth device on the second channel.

8. The method of claim 1, wherein the first Bluetooth device is a Bluetooth headset.

9. The method of claim 1, wherein the audio stream is streamed using an advanced audio distribution profile (A2DP) and the call is routed to the first Bluetooth device using a hands-free profile (HFP).

10. A Bluetooth host device for wireless communication, comprising:
a processor;
memory in electronic communication with the processor; and
instructions stored in the memory, the instructions being executable by the processor to:
stream an audio stream from the Bluetooth host device to a first Bluetooth device and a second Bluetooth device;
receive a call at the Bluetooth host device;
send call indications to both the first Bluetooth device and the second Bluetooth device;
receive an answer call message from the first Bluetooth device;
route the call to the first Bluetooth device and cease streaming the audio stream to the first Bluetooth device; and
continue streaming the audio stream to the second Bluetooth device.

11. The Bluetooth host device of claim 10, further comprising instructions executable to:
terminate the call on the first Bluetooth device; and
resume streaming the audio stream to the first Bluetooth device.

12. The Bluetooth host device of claim 10, wherein the Bluetooth host device simultaneously streams the audio stream and sends the call indications to both the first Bluetooth device and the second Bluetooth device.

13. The Bluetooth host device of claim 10, wherein the instructions executable to continue streaming the audio stream to the second Bluetooth device comprise instructions executable to stream the audio stream to the second Bluetooth device while the first Bluetooth device conducts the call.

14. The Bluetooth host device of claim 10, wherein the Bluetooth host device establishes a first channel with the first Bluetooth device and a second channel with the second Bluetooth device using a single Bluetooth transceiver.

15. The Bluetooth host device of claim 14, wherein the Bluetooth host device streams the audio stream and sends the call indications to the first Bluetooth device on the first channel and the Bluetooth host device streams the audio stream and sends the call indications to the second Bluetooth device on the second channel.

16. The Bluetooth host device of claim 14, wherein the Bluetooth host device establishes the call with the first Bluetooth device on the first channel while continuing to stream the audio stream to the second Bluetooth device on the second channel.

17. An apparatus for wireless communication, comprising:
means for streaming an audio stream from the apparatus to a first Bluetooth device and a second Bluetooth device;
means for receiving a call at the apparatus;
means for sending call indications to both the first Bluetooth device and the second Bluetooth device;
means for receiving an answer call message from the first Bluetooth device;
means for routing the call to the first Bluetooth device and cease streaming the audio stream to the first Bluetooth device; and
means for continuing streaming the audio stream to the second Bluetooth device.

18. The apparatus of claim 17, further comprising:
means for terminating the call on the first Bluetooth device; and
means for resuming streaming the audio stream to the first Bluetooth device.

19. The apparatus of claim 17, wherein the apparatus simultaneously streams the audio stream and sends the call indications to both the first Bluetooth device and the second Bluetooth device.

20. The apparatus of claim 17, wherein the means for continuing streaming the audio stream to the second Bluetooth device comprise means for streaming the audio stream to the second Bluetooth device while the first Bluetooth device conducts the call.

21. The apparatus of claim 17, wherein the apparatus establishes a first channel with the first Bluetooth device and a second channel with the second Bluetooth device using a single Bluetooth transceiver.

22. The apparatus of claim 21, wherein the apparatus streams the audio stream and sends the call indications to the first Bluetooth device on the first channel and the apparatus streams the audio stream and sends the call indications to the second Bluetooth device on the second channel.

23. The apparatus of claim 21, wherein the apparatus establishes the call with the first Bluetooth device on the first channel while continuing to stream the audio stream to the second Bluetooth device on the second channel.

24. A computer-program product for wireless communication, the computer-program product comprising a non-transitory computer-readable medium having instructions thereon, the instructions comprising:
code for causing a Bluetooth host device to stream an audio stream to a first Bluetooth device and a second Bluetooth device;
code for causing the Bluetooth host device to receive a call;
code for causing the Bluetooth host device to send call indications to both the first Bluetooth device and the second Bluetooth device;
code for causing the Bluetooth host device to receive an answer call message from the first Bluetooth device;
code for causing the Bluetooth host device to route the call to the first Bluetooth device and cease streaming the audio stream to the first Bluetooth device; and
code for causing the Bluetooth host device to continue streaming the audio stream to the second Bluetooth device.

25. The computer-program product of claim 24, further comprising:
code for causing the Bluetooth host device to terminate the call on the first Bluetooth device; and
code for causing the Bluetooth host device to resume streaming the audio stream to the first Bluetooth device.

26. The computer-program product of claim 24, wherein the Bluetooth host device simultaneously streams the audio stream and sends the call indications to both the first Bluetooth device and the second Bluetooth device.

27. The computer-program product of claim 24, wherein the code for causing the Bluetooth host device to continue streaming the audio stream to the second Bluetooth device comprises code for causing the Bluetooth host device to stream the audio stream to the second Bluetooth device while the first Bluetooth device conducts the call.

28. The computer-program product of claim 24, wherein the Bluetooth host device establishes a first channel with the first Bluetooth device and a second channel with the second Bluetooth device using a single Bluetooth transceiver.

29. The computer-program product of claim 28, wherein the Bluetooth host device streams the audio stream and sends the call indications to the first Bluetooth device on the first channel and the Bluetooth host device streams the audio stream and sends the call indications to the second Bluetooth device on the second channel.

30. The computer-program product of claim 28, wherein the Bluetooth host device establishes the call with the first Bluetooth device on the first channel while continuing to stream the audio stream to the second Bluetooth device on the second channel.
